(19) United States
(12) Patent Application Publication
(10) Pub. No.: US 2012/0136545 A1
(43) Pub. Date: May 31, 2012

(54) METHOD FOR OPERATING A MOTOR VEHICLE AND MOTOR VEHICLE

(75) Inventors: Oliver SCHEPP, Idstein (DE); Ingobert LASSRICH, Trebur (DE); Ali KHANAFER, Mainz (DE); Oliver WAGNER, Gross-Gerau (DE)

(73) Assignee: GM GLOBAL TECHNOLOGY OPERATIONS LLC, Detroit, MI (US)

(21) Appl. No.: 13/301,119

(22) Filed: Nov. 21, 2011

(30) Foreign Application Priority Data
Nov. 22, 2010 (DE) 10 2010 052 129.9

(51) Int. Cl. G06F 7/00; H04N 7/18

(52) U.S. Cl. 701/70; 348/148; 701/1; 348/E07.085

(57) ABSTRACT

A method is provided for operating a motor vehicle. The method includes, but is not limited to determining whether the roadway in the area of the motor vehicle forms an approach to another roadway. If it is determined that the roadway forms an approach to another roadway, a first lane of the roadway in which the motor vehicle is located is determined with data of an optical camera of the motor vehicle. In addition, a direction of travel along in the first lane is determined and determined whether the motor vehicle is traveling in the direction opposite the direction of travel. If it is determined that the motor vehicle is traveling in the direction opposite the direction of travel, a first warning message is output and/or at least one apparatus (e.g., braking apparatus, a drive apparatus, and a steering apparatus) is actuated.

### CROSS-REFERENCE TO RELATED APPLICATION

This application claims priority to German Patent Application No. 102010052129.9, filed Nov. 22, 2010, which is incorporated herein by reference in its entirety.

### TECHNICAL FIELD

The technical field relates to a method for operating a motor vehicle traveling on a roadway in a first direction of travel, a motor vehicle, a computer program product, and a computer-readable medium.

### BACKGROUND

Known from DE 101 26 548 A1 is an apparatus for preventing driving on a roadway in the direction opposite to a predefined direction of travel. The apparatus comprises, on the one hand, one or more road-side emitters and on the other hand, one or more optionally sensor-like receivers on the vehicle side, designed to receive the signals of the road-side emitter. The road-side emitter or emitters deliver one or more signals continuously or merely in the event of a vehicle driving past in a direction of travel opposite to the predefined direction of travel. This signal is processed by the vehicle-side receiver or a vehicle-side central data processing device connected to this and is delivered to the onboard electronics and/or the gasoline supply and/or the ignition coil and/or the engine controller and/or the brakes in the form of signals and/or such control variables that a warning indication is displayed to the driver of the vehicle and/or that the speed of the vehicle undergoes a complete or at least partial and continuous or abrupt reduction.

It is at least one object to provide a method for operating a motor vehicle driving on a roadway, a motor vehicle, a computer program product, and a computer-readable medium, which allow a simple and reliable determination of an incorrect approach of the motor vehicle onto roadways, in particular onto freeways and onto highways. In addition, other objects, desirable features and characteristics will become apparent from the subsequent summary and detailed description, and the appended claims, taken in conjunction with the accompanying drawings and this background.

### SUMMARY

A method for operating a motor vehicle driving on a roadway comprises the following steps. It is determined whether the roadway in the area of the motor vehicle forms an approach to another roadway. If it is determined that the roadway in the area of the motor vehicle forms an approach to another roadway, a first lane of the roadway in which the motor vehicle is located, is determined by means of data of at least one optical camera of the motor vehicle. In addition, a direction of travel to be driven along in the first lane is determined. In addition, it is determined whether the motor vehicle is traveling in the direction opposite the direction of travel to be driven along in the first lane. If it is determined that the motor vehicle is traveling in the direction opposite the direction of travel to be driven along in the first lane, a first warning message is output and/or at least one apparatus of the motor vehicle is automatically actuated, selected from the group consisting of a braking apparatus, a drive apparatus, and a steering apparatus.

In this context, here and subsequently an automatic actuation of the at least one apparatus is understood to mean in particular also an actuation that effects a deactivation or a switch-off of the apparatus. For example, an actuation of the drive apparatus is also understood as a switching off an engine of the motor vehicle. Furthermore, here and subsequently determining whether the roadway in the area of the motor vehicle forms an approach to another roadway is understood to mean a corresponding determination in a neighborhood of the motor vehicle. In particular, this is understood as a determination in a partial area of the neighborhood of the motor vehicle which is disposed ahead of the motor vehicle in the direction of travel of the motor vehicle.

The method for operating the motor vehicle makes it possible to determine an incorrect approach of the motor vehicle onto the further roadway by determining the direction of travel to be driven along in the first lane and to determine whether the motor vehicle is driving in the direction opposite to the direction of travel to be driven along in the first lane. At the same time, the method has the advantage that the first lane of the roadway in which the motor vehicle is located can be determined in a simple and reliable manner by means of a vehicle's own sensor in the form of at least one optical camera. As a result, the respective instantaneous driving situation can be taken into account to an increased extent. The method according therefore advantageously enables a simple and reliable determination of an incorrect approach onto the further roadway taking into account the instantaneous traffic situation. By automatically outputting the first warning message or automatically actuating the at least one apparatus of the motor vehicle, the traffic safety can be further increased since involved road users can be made aware of the possible hazardous situation in good time and can react accordingly or an automatic braking process of the motor vehicle can be accomplished. The determination of the first lane by means of the data of the at least one optical camera preferably includes a determination of boundary markings of the lanes of the roadway. This enables a simple and reliable determination of the lane.

In a further embodiment of the method, the determination of the first lane of the roadway, in which the motor vehicle is located, is additionally made by means of map data stored in a storage apparatus. The storage apparatus can thereby in particular be part of the motor vehicle, typically a navigation system of the motor vehicle. This advantageously increases the accuracy of the determination since the data of the at least one optical camera can be compared with the map data and as a result, the determined data can be plausible.

A further plausible option can additionally be accomplished by means of data of a so-called E-horizon (i.e., electronic horizon) of the motor vehicle, which is also designated as Adasis protocol (ADAS—Advanced Driver Assistance System). In this context, the E-horizon can be understood as an interface between a driver assistance system and the navigation system of the motor vehicle, whereby map data of the navigation system are available to the driver assistance system.

The determination of as to whether the roadway in the area of the motor vehicle forms an approach to another roadway can be made by means of data of the at least one optical camera and/or by means of map data stored in the storage apparatus. This has the advantage that the provision of an additional road-side emitter which signals an approach can be omitted. In turn, the determined data can advantageously be plausible in the event of the determination being made both by means of the at least one optical camera and also by means of the map data.

In a further embodiment of the method, the determination as to whether the motor vehicle is traveling in the direction opposite the direction of travel to be driven along in the first lane is made by determining a position of the first lane on the roadway and by means of map data stored in the storage apparatus. The determination of the position of the first lane on the roadway is preferably made by means of data of the at least one optical camera. If, for example, it is determined by means of the data of the at least one optical camera that the first lane is disposed in a left area of the roadway relative to the direction of travel of the motor vehicle and a requirement to keep to the right or drive on the right is identified by means of a country code stored on the map data, it can thereby be concluded that the first lane is to be driven along in the direction opposite to the direction of travel to be driven along. Accordingly, if there is a requirement to keep to the left or drive on the left, this can be accomplished by determining that the first lane is disposed in a right area of the roadway. The said example in turn have the advantage that the instantaneous driving situation can be taken into account to a particularly high degree since merely the information about the requirement to drive on the appropriate side is deduced from the map data.

After outputting the first warning message and/or automatically actuating the at least one apparatus, the method preferably additionally comprises the following steps. A determination is made as to whether in the area of the motor vehicle lanes are disposed adjacent to the first lane. If at least one lane is disposed adjacent to the first lane in the area of the motor vehicle, a direction of travel to be driven along in the at least one lane is determined In addition, it is determined whether the motor vehicle is approaching the at least one lane in the direction opposite the direction of travel to be driven along in the at least one lane. If it is determined that the motor vehicle is approaching the at least one lane in the direction opposite the direction of travel to be driven along in the at least one lane, a second warning message is output and/or at least one apparatus of the motor vehicle is automatically actuated, selected from the group consisting of the braking apparatus, the drive apparatus, and the steering apparatus. The embodiment thus forms a two-stage system where the first stage includes determining that the approach road is being driven along in the direction opposite to the direction of travel to be driven along and the second stage includes determining an approach onto the further roadway in the direction opposite to the direction of travel to be driven along. An incorrect approach of the motor vehicle onto the further roadway can thus be determined during the entire approach process and the said measures can be carried out.

The determination as to whether lanes are disposed adjacent to the first lane in the area of the motor vehicle, is preferably accomplished by means of data of the at least one optical camera and/or by means of map data stored in the storage apparatus. In the case of the determination being made by means of the at least one optical camera, as a result the particular instantaneous traffic situation can again be taken into account to an increased degree. The use of both systems has the advantage that the data can be mutually plausible.

The determination as to whether the motor vehicle is approaching the at least one lane in the direction opposite the direction of travel to be driven along in the at least one lane can be accomplished by determining a position of the first lane relative to the at least one lane and by means of map data stored in the storage apparatus. The determination of the position of the first lane relative to the at least one lane is preferably made by means of data of the at least one optical camera. For example, the approach onto the at least one lane can be monitored in a camera-based manner and when merging on the right in right-hand traffic, i.e., if the at least one lane in the longitudinal direction of the motor vehicle is located on the right of the first lane or when merging on the left in left-hand traffic, an incorrect approach can be concluded. The examples in turn have the advantage that the instantaneous driving situation can be taken into account to a particularly high degree since merely the information about the requirement for driving on the appropriate side is obtained from the map data.

The first warning message and/or the second warning message are preferably output inside the motor vehicle. In this case, the first warning message and/or the second warning message can be a visual and/or audible and/or haptic warning message. As a result, the occupants of the motor vehicle, in particular the driver of the motor vehicle can be warned of an incorrect approach onto the further roadway. As a result, they have the possibility to respond in good time.

In a further embodiment, the first warning message and/or the second warning message are output to other road users, typically to other motor vehicles, in particular by means of automatic actuation of a horn and/or at least one light signal device of the motor vehicle, for example, at least one headlamp or a warning flashing light, and/or by means of a vehicle-to-vehicle communication apparatus. As a result, these can advantageously be warned of the incorrect approach of the motor vehicle.

The first warning message and/or the second warning message can additionally or alternatively be output to a central location by means of a vehicle-to-infrastructure communication apparatus, in particular to a traffic control center. This has the advantage that the largest possible number of other road users can be warned of the incorrect approach of the motor vehicle.

The actuation of the at least one apparatus of the motor vehicle is preferably effected in such a manner that the speed of the motor vehicle is reduced, in particular in such a manner that the motor vehicle is braked until it stops. Additionally or alternatively, the steering apparatus can be actuated in such a manner that the motor vehicle is brought into an edge zone of the roadway, for example, a hard shoulder.

In a further embodiment of the method, it is additionally determined whether a changed traffic management system exists on the roadway in the area of the motor vehicle. The output of the first warning message and/or the automatic actuation of the at least one apparatus of the motor vehicle takes place in this case if it is determined that the motor vehicle is traveling in the direction opposite the direction of travel to be driven along in the first lane and if no changed traffic management system exists on the roadway. Accordingly, the output of the second warning message and/or the automatic actuation of the at least one apparatus of the motor vehicle takes place if it is determined that the motor vehicle is approaching onto the at least one lane in the direction opposite the direction of travel to be driven along in the at least one lane and if no changed traffic management system exists on the roadway.

Here and subsequently, a changed traffic management system on the roadway is understood to mean that the traffic management system on the roadway differs from a predetermined traffic management system. Accordingly, no changed traffic management system on the roadway means that the traffic management system corresponds to the predetermined traffic management system. The embodiment starts from the consideration that due to a changed traffic management system for example, in the form of a shift of the roadway due to road works, the motor vehicle is traveling in a lane which is normally to be driven in the opposite direction. The embodiment of the method advantageously enables the output of an incorrect warning message or an incorrect automatic braking or evasion to be avoided.

The application additionally relates to a motor vehicle comprising a first determination apparatus where the first determination apparatus is configured to determine whether a roadway in an area of the motor vehicle forms an approach to another roadway. In addition, the motor vehicle has a determination unit comprising at least one optical camera where the determination unit is configured to determine a first lane of the roadway in which the motor vehicle is located by means of data of the at least one optical camera in particular if it is determined that the roadway in the area of the motor vehicle forms an approach to another roadway. In addition, the motor vehicle has a second determination apparatus configured to determine a direction of travel to be driven along in the first lane. Furthermore, the motor vehicle has a third determination apparatus configured to determine whether the motor vehicle is traveling in the direction opposite the direction of travel to be driven along in the first lane. Furthermore, the motor vehicle has an output apparatus configured to output a first warning message if it is determined that the motor vehicle is traveling in the direction opposite the direction of travel to be driven along in the first lane. Additionally or alternatively to the output apparatus, the motor vehicle has an actuation apparatus configured to automatically actuate at least one apparatus of the motor vehicle, selected from the group consisting of a braking apparatus, a drive apparatus, and a steering apparatus if it is determined that the motor vehicle is traveling in the direction opposite the direction of travel to be driven along in the first lane.

A computer program product is provided that, when it is executed on a processing unit of a first motor vehicle, instructs the processing unit to execute the following steps. The processing unit is instructed to determine whether a roadway in an area of the motor vehicle forms an approach to another roadway. If it is determined that the roadway in the area of the motor vehicle forms an approach to another roadway, the processing unit is instructed to determine a first lane of the roadway in which the motor vehicle is located by means of data of the at least one optical camera of the motor vehicle. Furthermore, the processing unit is instructed to determine a direction of travel to be driven along in the first lane. The processing unit is further instructed to determine whether the motor vehicle is traveling in the direction opposite the direction of travel to be driven along in the first lane. If it is determined that the motor vehicle is traveling in the direction opposite the direction of travel to be driven along in the first lane, the processing unit is instructed to output a first warning message and/or to automatically actuate at least one apparatus of the motor vehicle, selected from the group consisting of a braking apparatus, a drive apparatus, and a steering apparatus.

A computer-readable medium on which a computer program product is stored is provided according an embodiment. The motor vehicle, the computer program product, and the computer-readable medium have the advantages already specified in connection with the method that are not listed again at this point to avoid repetitions. The motor vehicle is preferably an automobile or a truck in the aforesaid embodiments.

### BRIEF DESCRIPTION OF THE DRAWINGS

The present invention will hereinafter be described in conjunction with the following drawing figures, wherein like numerals denote like elements, and:

FIG. 1 shows a flow diagram of a method for operating a motor vehicle traveling on a roadway according to one embodiment;

FIG. 2A and FIG. 2B show a motor vehicle according to one embodiment; and

FIG. 3 shows components of the motor vehicle according to FIG. 2A and FIG. 2B.

### DETAILED DESCRIPTION

The following detailed description is merely exemplary in nature and is not intended to limit application and uses. Furthermore, there is no intention to be bound by any theory presented in the preceding background or summary or the following detailed description.

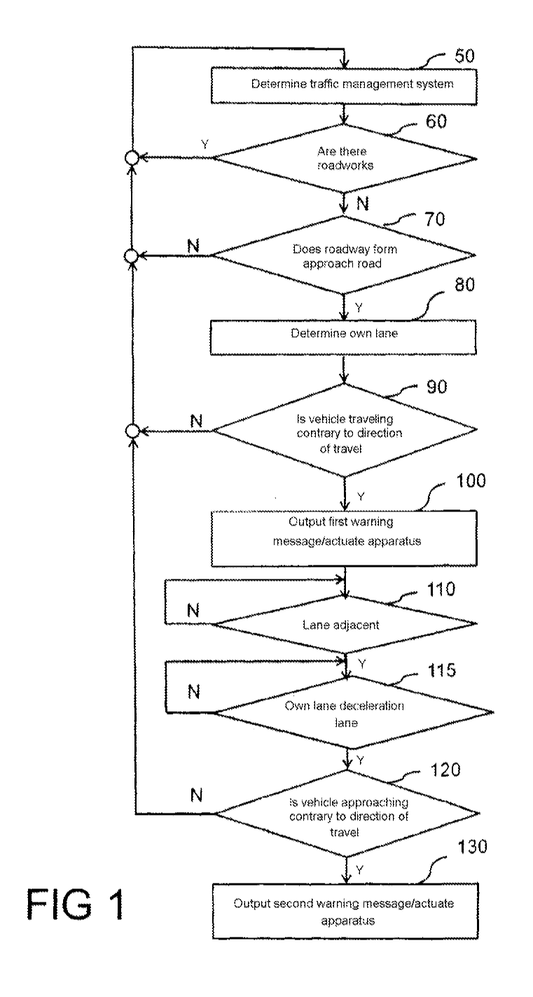

FIG. 1 shows a flow diagram of a method for operating a motor vehicle traveling on a roadway according to one embodiment. The motor vehicle in this case is, for example, an automobile or a truck. In a step 50 the instantaneous traffic management system on the roadway is determined in the area of the motor vehicle. In the embodiment shown this is accomplished by means of data of at least one optical camera of the motor vehicle.

In a step 60 it is checked by means of the determined data whether a changed traffic management system exists in the area of the motor vehicle. To this end it is determined in the embodiment shown whether road works on the roadway are located in front of the motor vehicle. The determination as to whether there are road works can be made, for example, by identifying road works signs or a narrowing of road markings in the images taken by the optical camera.

If it is determined that road works exist in the area of the motor vehicle, step 50 is executed repeatedly. If, on the other hand, it is determined that no road works exist and therefore there is no changed traffic management system in the area of the motor vehicle, in a step 70 it is determined whether the roadway in the area of the motor vehicle forms an approach to another roadway, preferably to a highway or a freeway. In this case, the determination as to whether the roadway in the area of the motor vehicle forms an approach to another roadway can be made by means of data of the at least one optical camera of the motor vehicle and/or by means of map data stored in a storage apparatus. The storage apparatus is typically part of a navigation system of the motor vehicle. For example, it can be determined whether the images recorded by the at least one optical camera contain a motorway sign. This can be accomplished by comparing the recorded images with a predetermined form and/or at least one predetermined color of the traffic sign, which are typically stored in another storage apparatus. Furthermore, the determined data can be plausible by means of data of an E horizon (electronic horizon) or an Adasis protocol. If the roadway in the area of the motor vehicle does not form an approach to another roadway, steps 50 and 60 are executed repeatedly.

If, on the other hand, the roadway in the area of the motor vehicle forms an approach to another roadway, in a step 80 a first lane of the roadway is determined in which the motor vehicle is located, i.e., the lane position of the motor vehicle on the approach road is determined. The first lane of the roadway is determined in this case by means of data of the at least one optical camera of the motor vehicle. In addition, the determination of the first lane of the roadway can be made by means of map data stored in the storage apparatus, whereby the determined data can again be plausibilized in an advantageous manner.

In a step 90 it is determined in the embodiment shown whether the motor vehicle is traveling in a direction opposite to the direction of travel to be driven along in the first lane. The direction of travel to be driven along in the first lane is determined, for example, by means of map data stored in the storage apparatus. In the embodiment shown, the determination as to whether the motor vehicle is traveling in a direction opposite to the direction of travel to be driven along in the first lane and therefore traveling in the wrong lane of the approach road is made by determining a position of the first lane on the roadway by means of data of the at least one optical camera and by means of map data stored in the storage apparatus, in particular by means of the country codes stored on the map data. If, for example, right-hand traffic or a requirement to drive on the right is identified by means of the stored country code and it is determined by means of the data of the at least one optical camera that the motor vehicle is located on the left lane of the roadway, it can thereby be concluded that the approach road is being driven along in the direction opposite to the direction of travel to be driven along. The same applies accordingly when driving along the right lane of the approach road when left-hand traffic or a requirement to drive on the left has been determined

If it is determined that the motor vehicle is traveling in the direction of travel to be driven along in the first lane, steps 50, 60, and optionally 70, 80, and 90 are executed repeatedly. If, on the other hand, it is determined that the motor vehicle is traveling in a direction opposite to the direction of travel to be driven along in the first lane, in a step 100 a first warning message is output and/or at least one apparatus of the motor vehicle is automatically actuated, selected from the group consisting of a braking apparatus, a drive apparatus, and a steering apparatus.

The warning message can be output as a visual and/or audible and/or haptic warning message inside the motor vehicle. In addition, the warning message can additionally or alternatively be output to other road users by appropriate automatic actions of the wrongly approaching motor vehicle, in particular by automatic actuation of a horn and/or at least one light signaling device of the motor vehicle, for example by warning flashing or turning the headlamps to full beam and/or by means of a vehicle-to-vehicle communication apparatus and oncoming traffic thereby warned. Furthermore, the first warning message can additionally or alternatively be output by means of a vehicle-to-infrastructure communication apparatus to a central location, typically a traffic control center.

After outputting the first warning message or automatic actuation of the at least one apparatus, in a step 110 it is determined whether lanes adjacent to the first lane are disposed in the area of the motor vehicle. If no lane is disposed adjacent to the first lane, step 110 is executed repeatedly. If, on the other hand, at least one lane adjacent to the first lane is disposed in the area of the motor vehicle, in a step 115 it is determined whether the at least one lane is part of a roadway which has several lanes in a direction of travel and therefore typically forms a freeway or highway. This is accomplished, for example, by means of data of the at least one optical camera and/or by means of map data stored in the storage apparatus. As a result, in the embodiment shown it is determined whether the motor vehicle is already in a deceleration lane of the further roadway or whether its own lane forms the deceleration lane.

If the further lane does not form part of such a multilane roadway, step 115 is executed repeatedly. If the at least one lane forms a part of such a multilane roadway, i.e., the vehicle's own lane is the deceleration lane or deceleration strip, in the step 120 it is further determined whether the motor vehicle is approaching onto the at least one lane in the direction opposite the direction of travel to be driven along in the at least one lane. In this case, a direction of travel to be driven along in the at least one lane is determined by means of map data stored in the storage apparatus.

In a further embodiment it is determined in a joint step whether the at least one lane is a part of a roadway having several lanes in one direction of travel and it is determined whether the motor vehicle is approaching onto this in the direction opposite the direction of travel to be driven along in the lane. In the embodiment shown, the determination as to whether the motor vehicle is approaching in the direction opposite the direction of travel to be driven along is made by determining a position of the first lane relative to the at least one lane and by means of map data stored in the storage apparatus, in particular by means of country codes stored on the map data. The position of the first lane relative to the at least one lane is determined by means of data of the at least one optical camera.

The approach onto the lane disposed adjacent to the first lane and therefore onto the further roadway is consequently monitored in a camera-based manner. This is accomplished by detecting the roadway geometry by means of data of the at least one optical camera, in particular by determining a number of lanes and a position of the approach or deceleration lane. The determined data can in turn be plausibilized by means of navigation information or Adasis protocol.

If, for example, right-hand traffic or a requirement to drive on the right is identified by means of the country code stored on the map data and in addition, a right merging of the motor vehicle is determined, i.e., the further lane is located in the direction of travel of the motor vehicle to the right of the first lane, an approach taking place in the direction opposite the direction of travel to be driven along is concluded. The same applies accordingly when left merging in left-hand traffic.

If it is determined that the motor vehicle is approaching onto the at least lane in the direction of travel to be driven along, steps 50, 60, and optionally 70 to 110 are executed repeatedly. If it determined that the motor vehicle is approaching onto the at least one lane in the direction opposite the direction of travel to be driven along, in a step 130 a second warning message is output and/or at least one apparatus of the motor vehicle is automatically actuated, selected from the group consisting of the braking apparatus, the drive apparatus, and the steering apparatus. For example, an engine of the motor vehicle can be switched off and/or a steering of the motor vehicle can be actuated in such a manner that the motor vehicle does not approach onto the at least one lane.

The second warning message is preferably also output as a visual and/or audible and/or haptic warning message inside the motor vehicle. In addition, the second warning message can additionally or alternatively be output to other road users, in particular by means of automatic actuation of a horn and/or the at least one light signaling device of the motor vehicle, for example, by warning flashing or flashing the headlamps and/or by means of the vehicle-to-vehicle communication apparatus. Furthermore, the second warning message can additionally or alternatively be output to the central location, for example, the traffic control center, by means of the vehicle-to-infrastructure communication apparatus.

The method according to the embodiment shown therefore enables a two-stage system in which both before the approach of the motor vehicle onto the further roadway in the direction opposite the direction of travel to be driven along and also when the motor vehicle is approaching onto the further roadway in the direction opposite the direction of travel to be driven along, one warning message is output in each case and/or one automatic intervention into the motor vehicle is made in each cases. The further roadway typically forms a freeway or a highway.

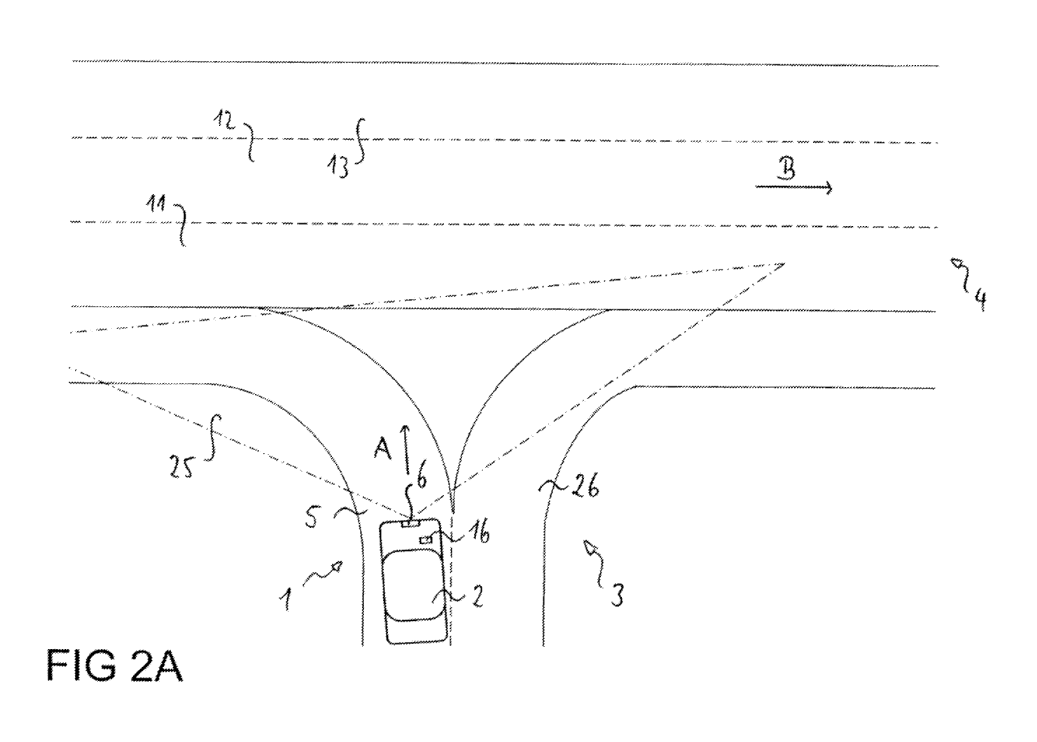

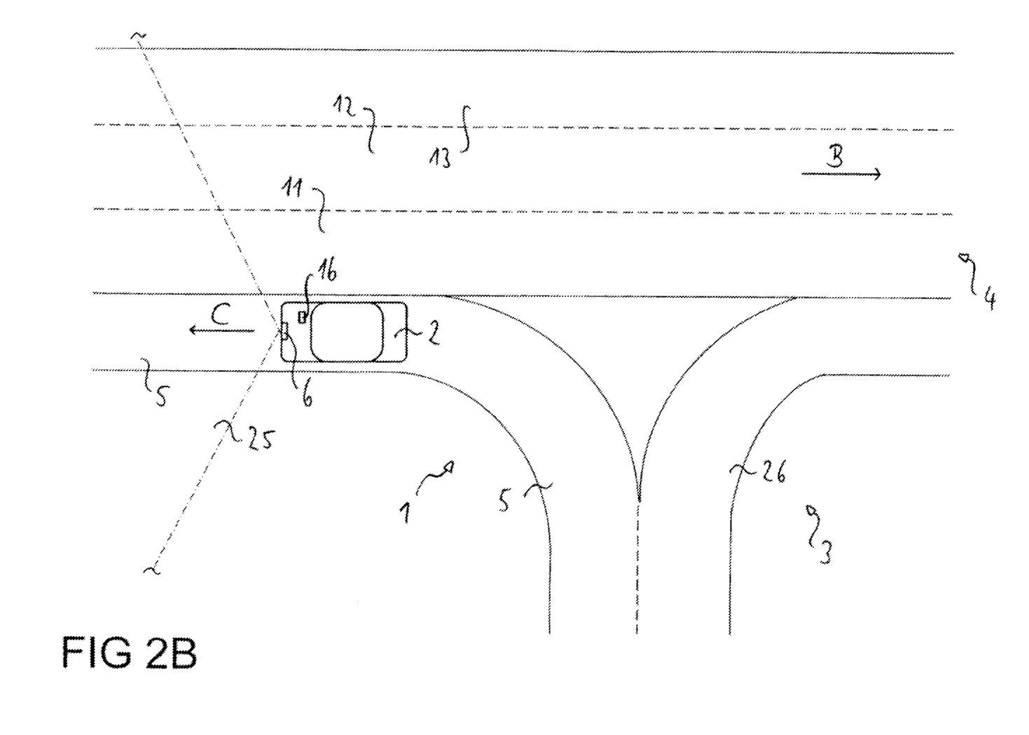

FIG. 2A and FIG. 2B shows a motor vehicle 2 according to one embodiment. In the embodiment shown the motor vehicle 2 is an automobile and has an optical camera 6. The optical camera 6 has a detection range 25 shown schematically by means of a dot-dash line in FIG. 2A and FIG. 2B.

In FIG. 2A the motor vehicle 2 is traveling on a roadway 1 in a direction of travel shown schematically by means of an arrow A. In the area of the motor vehicle 2 the roadway 1 forms an approach road 3 to another roadway 4. In the embodiment shown the roadway 4 is part of a freeway and has lanes 11, 12, and 13, which are to be driven along in a direction of travel shown schematically by means of an arrow B. In the embodiment shown a traffic situation with right-hand traffic is shown.

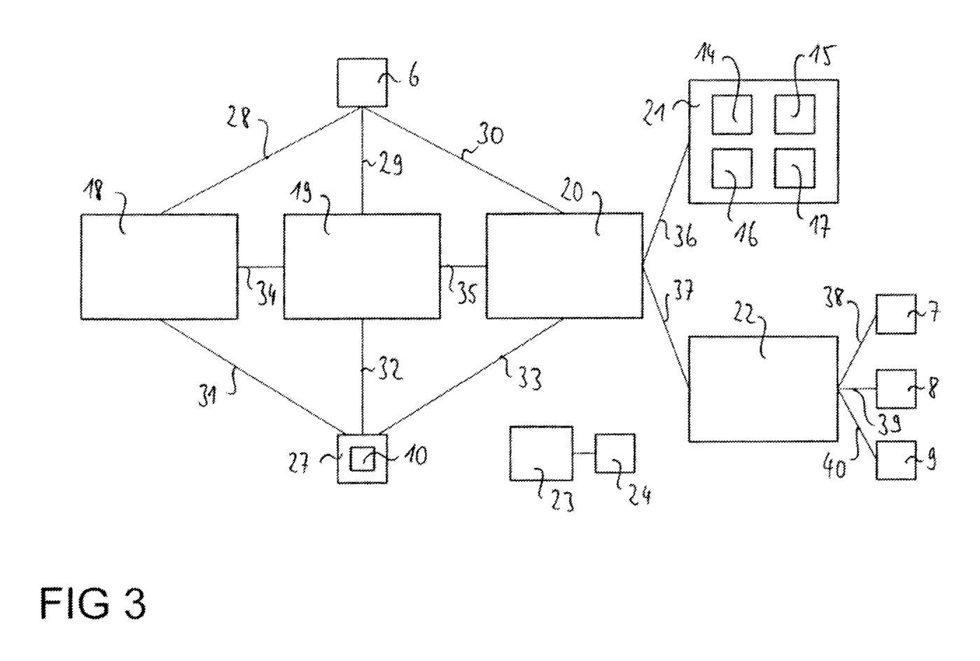

The roadway 1 has lanes 5 and 26, where the lane 5 forms a left-hand lane and the lane 26 forms a right-hand lane of the roadway 1. The motor vehicle 2 is traveling in the left-hand lane 5 in the direction of travel depicted by means of the arrow A and therefore in the traffic situation shown, in the direction opposite the direction of travel to be driven along in the lane 5. As will be further explained in connection with FIG. 3, the approach of the motor vehicle 2 in the direction opposite the direction of travel to be driven along can be determined by means of data of the optical camera 6 and for example, the first warning message can be transmitted to other road users by means of a vehicle-vehicle communication apparatus 16 of the motor vehicle 2. FIG. 2B shows the motor vehicle 2 during a process of approach onto the lane 11 of the further roadway 4. Components having the same functions as in FIG. 2A are characterized by the same reference numerals and not explained in detail hereinafter.

The motor vehicle 2 is traveling in a direction of travel shown schematically by means of an arrow C in the lane 5 and therefore in the direction opposite the direction of travel to be driven along in the lane 5, which forms a deceleration lane, also the roadway 4. As will be explained in further detail in connection with FIG. 3, the incorrect merging of the motor vehicle 2 onto the lane 11 of the roadway 4 can be determined by means of data of the optical camera 6 and for example, a second warning message can be transmitted to other road users by means of the vehicle-to-vehicle communication apparatus 16.

FIG. 3 shows components of the motor vehicle according to FIG. 2A and FIG. 2B. Components having the same functions as in FIG. 2A and FIG. 2B are characterized with the same reference numbers and are not explained in detail in the following. The motor vehicle not shown in detail in FIG. 3 has a first determination apparatus 18 configured to determine whether a roadway in an area of the motor vehicle forms an approach to another roadway. Furthermore, the first determination apparatus 18 is configured to determine whether lanes adjacent to the first lane are disposed in the area of the motor vehicle. To this end, in the embodiment shown the first determination apparatus 18 is connected via a signal line 28 to the optical camera 6 and via a signal line 31 to a navigation system 27 of the motor vehicle. The navigation system 27 includes a storage apparatus 10 with map data stored thereon.

In the embodiment shown, the first determination apparatus 18 additionally forms a determination unit configured to determine that lane of the roadway in which the motor vehicle is located by means of data of the optical camera 6, in particular if it is determined that the roadway in the area of the motor vehicle forms an approach to another roadway. Furthermore, the determination unit is configured to determine a position of the first lane relative to at least one further lane by means of data of the optical camera 6.

The motor vehicle furthermore has a second determination apparatus 19 configured to determine a direction of travel to be driven along in the first lane or the at least one further lane disposed adjacent to the first lane. To this end, in the embodiment shown, the second determination apparatus 19 is connected via a signal line 29 to the optical camera 6 and via a signal line 32 to the navigation system 27. For example, the determination of the direction of travel to be driven along can be made by determining from direction arrows applied to the respective lane in the images recorded by the optical camera 6. In addition, the second determination apparatus 19 is connected via a signal line 34 to the first determination apparatus 18.

Furthermore, the motor vehicle has a third determination apparatus 20 configured to determine whether the motor vehicle is traveling in the direction opposite the direction of travel to be driven along in the first lane. Furthermore, the third determination apparatus 20 is configured to determine whether the motor vehicle is approaching onto the further lane in the direction opposite the direction of travel to be driven along in the further lane. To this end, the third determination apparatus 20 is connected via a signal line 30 to the optical camera 6 and via a signal line 33 to the navigation system 27. Furthermore, the third determination apparatus 20 is connected via a signal line 35 to the second determination apparatus 19. In addition, the third determination apparatus 20 is connected via a signal line 36 to an output apparatus 21 and via a signal line 37 to an actuation apparatus 22 of the motor vehicle.

The output apparatus 21 is configured to output a first warning message if it is determined that the motor vehicle is traveling in the direction opposite the direction of travel to be driven along in the first lane. Furthermore, the output apparatus 21 is configured to output a second warning message if it is determined that the motor vehicle is approaching onto the further lane in the direction opposite the direction of travel to be driven along in the further lane. The first and/or second warning message is preferably output inside the motor vehicle. As a result, the occupants of the motor vehicle, for example, the driver of the motor vehicle, can be warned of an approach in the wrong direction of travel.

Additionally or alternatively, the first and/or second warning message can be output or transmitted to other road users. To this end the output apparatus 21 is configured to automatically actuate a horn 14 and a light signaling device 15 of the motor vehicle. The light signaling device 15 in this case includes at least one headlamp or a warning flashing light. Furthermore, the output apparatus 21 is configured to output the first and/or the second warning message by means of the vehicle-to-vehicle communication apparatus 16 and a vehicle-to-infrastructure communication apparatus 17.

The actuation apparatus 22 is configured to automatically actuate a braking apparatus 7, a drive apparatus 8, and/or a steering apparatus 9 of the motor vehicle in particular if it is determined that the motor vehicle is traveling in the direction opposite the direction of travel to be driven along in the first lane and/or if it is determined that the motor vehicle is approaching onto the further lane in the direction opposite the direction of travel to be driven along in the further lane. To this end, the actuation apparatus 22 is connected via a control line 38 to the braking apparatus 7, via a control line 39 to the drive apparatus 8, and via a control line 40 to the steering apparatus 9.

Furthermore, the motor vehicle has a processing unit 23 and a computer-readable medium 24, where a computer program product is stored on the computer-readable medium 24, which, when it is executed on the processing unit 23, instructs the processing unit 23 to execute the said steps of the method according to the application, in particular the embodiment shown in FIG. 1, by means of the said elements. To this end the processing unit 23 is connected directly or indirectly to the said components in a manner not shown.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for operating a motor vehicle driving on a roadway, comprising:
determining whether the roadway in an area of the motor vehicle forms an approach to another roadway;
determining a first lane of the roadway in which the motor vehicle is located with data of an optical camera of the motor vehicle if it is determined that the roadway in the area of the motor vehicle forms the approach to the another roadway;
determining a direction of travel to be driven along in the first lane,
determining whether the motor vehicle is traveling in a direction opposite the direction of travel to be driven along in the first lane,
performing an action if it is determined that the motor vehicle is traveling in the direction opposite the direction of travel to be driven along in the first lane.

2. The method according to claim 1, wherein the action is generating a first warning message.

3. The method according to claim 1, wherein the action is an automatic actuation of an apparatus of the motor vehicle.

4. The method according to claim 3, wherein the apparatus of the motor vehicle is a braking apparatus.

5. The method according to claim 1, wherein the determining of the first lane of the roadway in which the motor vehicle is located is additionally made with map data stored in a storage apparatus.

6. The method according to claim 1, wherein the determining whether the roadway in the area of the motor vehicle forms the approach to another roadway is made with the data of the optical camera.

7. The method according to claim 1, wherein the determining whether the roadway in the area of the motor vehicle forms the approach to another roadway is made with map data stored in a storage apparatus.

8. The method according to claim 1, wherein the determining whether the motor vehicle is traveling in the direction opposite the direction of travel to be driven along in the first lane is made by determining a position of the first lane on the roadway and with map data stored in a storage apparatus.

9. The method according to claim 8, wherein the determining of the position of the first lane on the roadway is made with the data of the optical camera.

10. The method according to claim 2, wherein after generating the first warning message, the method comprises:
determining whether lanes are disposed adjacent to the first lane in the area of the motor vehicle;
determining the direction of travel to be driven along in at least one lane if the at least one lane is disposed adjacent to the first lane in the area of the motor vehicle;
determining whether the motor vehicle is approaching the at least one lane in the direction opposite the direction of travel to be driven along in the at least one lane; and
generating a second warning message if it is determined that the motor vehicle is approaching the at least one lane in the direction opposite the direction of travel to be driven along in the at least one lane.

11. The method according to claim 2, wherein after generating the first warning message, the method comprises:
determining whether lanes are disposed adjacent to the first lane in the area of the motor vehicle;
determining the direction of travel to be driven along in at least one lane if the at least one lane is disposed adjacent to the first lane in the area of the motor vehicle;
determining whether the motor vehicle is approaching the at least one lane in the direction opposite the direction of travel to be driven along in the at least one lane; and
automatically actuating the apparatus of the motor vehicle.

12. A motor vehicle comprising:
a first determination apparatus configured to determine whether a roadway in an area of the motor vehicle forms an approach to another roadway;
a determination unit comprising an optical camera configured to determine a first lane of the roadway in which the motor vehicle is located with data of the optical camera if the roadway in the area of the motor vehicle forms the approach to the another roadway;
a second determination apparatus configured to determine a direction of travel to be driven along in the first lane;
a third determination apparatus configured to determine whether the motor vehicle is traveling in a direction opposite the direction of travel to be driven along in the first lane; and
an apparatus configured to take an action if the motor vehicle is traveling in the direction opposite the direction of travel to be driven along in the first lane.

13. The motor vehicle according to claim 12, wherein the apparatus is a first warning apparatus configured to generate a message if it is determined that the motor vehicle is traveling in the direction opposite the direction of travel to be driven along in the first lane.

14. The motor vehicle according to claim 12, wherein the apparatus is an actuation apparatus configured to automatically actuate an vehicle apparatus of the motor vehicle if the motor vehicle is traveling in the direction opposite the direction of travel to be driven along in the first lane.

15. The motor vehicle according to claim 14, wherein the apparatus of the motor vehicle is a drive apparatus.

16. A computer readable medium embodying a computer program product, said computer program product comprising:
an operating program for operating a motor vehicle driving on a roadway program, the operating program configured to:
determine whether a roadway in an area of the motor vehicle forms an approach to another roadway;
determine a first lane of the roadway in which the motor vehicle is located with data of an optical camera of the motor vehicle if it is determined that the roadway in the area of the motor vehicle forms the approach to the another roadway;
determine a direction of travel to be driven along in the first lane,
determine whether the motor vehicle is traveling in a direction opposite the direction of travel to be driven along in the first lane,
perform an action if it is determined that the motor vehicle is traveling in the direction opposite the direction of travel to be driven along in the first lane.

17. The computer readable medium embodying the computer program product according to claim 16, wherein the action is generating a first warning message.

18. The computer readable medium embodying the computer program product according to claim 16, wherein the action is an automatic actuation of an apparatus of the motor vehicle.

19. The computer readable medium embodying the computer program product according to claim 18, wherein the apparatus of the motor vehicle is a braking apparatus.

20. The computer readable medium embodying the computer program product according to claim 18, wherein the determining of the first lane of the roadway in which the motor vehicle is located is additionally made with map data stored in a storage apparatus.
